(19) United States
(12) Patent Application Publication
(10) Pub. No.: US 2025/0233253 A1
(43) Pub. Date: Jul. 17, 2025

(54) THREADED CELL AND CELL HOLDER FASTENING ASSEMBLIES FOR RECHARGEABLE ENERGY STORAGE SYSTEMS

(71) Applicant: GM GLOBAL TECHNOLOGY OPERATIONS LLC, Detroit, MI (US)

(72) Inventors: Mohammad Hamza KIRMANI, Troy, MI (US); Anthony Michael Coppola, Rochester Hills, MI (US)

(21) Appl. No.: 18/410,937

(22) Filed: Jan. 11, 2024

(51) Int. Cl. H01M 50/264; H01M 50/107; H01M 50/122; H01M 50/213; H01M 50/227; H01M 50/308

(52) U.S. Cl. CPC H01M 50/264; H01M 50/107; H01M 50/122; H01M 50/213; H01M 50/227; H01M 50/308

(57) ABSTRACT

A rechargeable energy storage system includes a cell holder tray including a plurality of vent passages each aligned with a corresponding one of a plurality of threaded features. A plurality of battery cells are each threadedly joined to a respective one of the plurality of threaded features of the cell holder tray.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a rechargeable energy storage system with cell and cell holder assembly with threaded interfaces.

Previously, battery packs have been provided with a venting system that allows the venting of individual battery cells while isolating the venting gasses from the remaining battery cells within the pack. The vent system must remain open for gas to traverse during a thermal event so that the gas must be able to reach the pack's vent port. The rest of the battery pack can be filled with potting resin (foamed or non-foamed) for electrical isolation, structural performance, and thermal insulation of the battery cells. Locating the cells on the cell holder is currently challenging for the battery pack assembly. Further, controlling the potting from leaking into the vent channel is challenging.

### SUMMARY

According to an aspect of the present disclosure, a rechargeable energy storage system includes a cell holder tray including a plurality of vent passages each aligned with a corresponding one of a plurality of threaded features. A plurality of battery cells are each threadedly joined to a respective one of the plurality of threaded features of the cell holder tray.

According to another aspect, the plurality of battery cells have an outer shell that is integrally threaded.

According to another aspect, the plurality of battery cells have a threaded sleeve.

According to another aspect, the threaded sleeve is made from metal.

According to another aspect, the threaded sleeve is made from one of a plastic and a composite material.

According to another aspect, the plurality of battery cells include one of a plastic shell and a composite shell.

According to another aspect, the plurality of battery cells include a metal shell.

According to another aspect, the plurality of battery cells are over-molded with a threaded sleeve.

According to another aspect, the plurality of threaded features of the cell holder tray are integrally formed with the cell holder tray.

According to another aspect, the cell holder tray includes an upper tray portion including the plurality of vent passages and the plurality of threaded features and a lower tray portion forming a plurality of vent channels in communication with the plurality of vent passages.

According to another aspect, the plurality of threaded features of the cell holder tray are formed from plastic.

According to another aspect, the plurality of threaded features of the cell holder tray are formed from metal.

According to another aspect, the plurality of threaded features of the cell holder tray are formed on an interior surface of a ring-shaped insert.

According to another aspect, the ring-shaped insert is ultrasonically inserted into the cell holder tray.

According to another aspect, the ring-shaped insert is heat inserted into the cell holder tray.

According to another aspect, the ring-shaped insert is press fit into the cell holder tray.

According to another aspect, the plurality of threaded features are molded into the cell holder tray.

According to another aspect, the plurality of threaded features are 3-D printed into the cell holder tray.

According to another aspect, the cell holder tray is made from plastic including one of nylon, polycarbonate, polypropylene and ABS.

According to another aspect, the plurality of threaded features are made from metal that is coated with a dielectric coating.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic view of a battery cell and battery cell holder assembly with threaded interfaces according to the principles of the present disclosure;

FIGS. 2A-2C schematically illustrate a process of attaching a pre-molded threaded sleeve to a battery cell according to the principles of the present disclosure; and

FIG. 3A schematically illustrates a process of overmolding a plastic threaded sleeve on a metal battery cell according to the principles of the present disclosure;

FIG. 3B schematically illustrates a process of overmolding a metal threaded sleeve on a metal battery cell according to the principles of the present disclosure;

FIG. 3C schematically illustrates a process of overmolding a plastic threaded sleeve on a plastic battery cell according to the principles of the present disclosure;

FIG. 3D schematically illustrates a process of overmolding a metal threaded sleeve on a plastic battery cell according to the principles of the present disclosure;

FIG. 4 is a schematic view of a battery cell holder tray with threaded interfaces according to the principles of the present disclosure;

FIG. 5 schematically illustrate a process of attaching a pre-molded threaded sleeve to a battery cell holder tray according to the principles of the present disclosure;

FIG. 6A schematically illustrates a process of ultrasonically inserting a threaded insert in a battery cell holder tray according to the principles of the present disclosure;

FIG. 6B schematically illustrates a process of press inserting a threaded insert in a battery cell holder tray according to the principles of the present disclosure; and

FIG. 6C schematically illustrates a process of heat inserting a threaded insert in a battery cell holder tray according to the principles of the present disclosure.

In the drawings, reference numbers may be reused to identify similar and/or identical elements.

### DETAILED DESCRIPTION

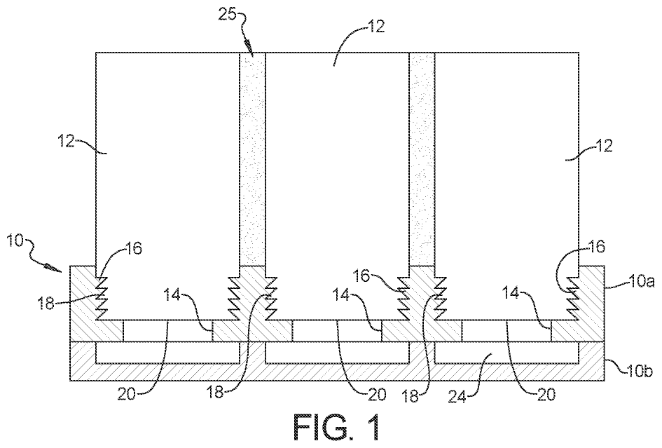

With reference to FIG. 1, a portion of a battery cell holder tray 10 is shown for supporting a plurality of battery cells 12 within a battery module. The cell holder tray 10 includes a plurality of vent passages 14 that each include a threaded interface 16. The threaded interface 16 is threadedly engaged with a corresponding threaded interface 18 on the battery cells 12. As shown in FIG. 1, the cell holder tray 10 can be formed of an upper tray portion 10a and a lower tray portion 10b. The upper tray 10a can define the vent passages 14 with the threaded interfaces 16 that are each in communication with a vent 20 of the battery cells 12 and the lower tray portion 10b define a plurality of vent channels 24 that are in communication with the vent passages 14. The cell holder tray 10 can be made from plastic including one of nylon, polycarbonate, polypropylene and ABS. An adhesive and/or a sealant can be used provided to secure and/or seal an interface between the battery cell holder tray 10 and the battery cells 12 and prevent the potting 25 from leaking into the vent channels 24 during assembly.

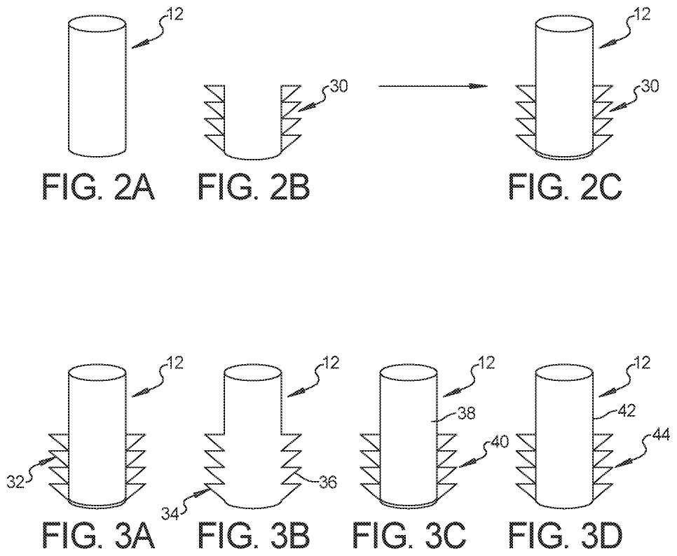

The threaded interface 18 on the battery cells 12 can be plastic or metallic. With reference to FIGS. 2A-2C, a process of attaching a pre-molded plastic or composite threaded sleeve 30 to a battery cell 12 is shown. The pre-molded plastic or composite threaded sleeve 30 can be shrunk onto the battery cell 12 or otherwise, adhered or secured. With reference to FIG. 3A, a threaded plastic sleeve 32 is shown that is over-molded directly onto the battery cell 12 shell. With reference to FIG. 3B, a battery cell 12 is shown with a metal shell 34 having a metal threaded interface 36 formed integrally with the metal shell 34. With reference to FIG. 3C, a battery cell 12 is shown with a plastic or composite shell 38 and having a plastic or composite threaded interface 40 that can be integrally formed or separately attached to the plastic or composite shell 38. As an alternative embodiment as shown in FIG. 3D, a battery cell 12 is shown with a plastic or composite shell 42 having a metal threaded interface 44 that can be attached to the plastic or composite shell 42. The metal threaded interface can be coated with a high temperature-resistant dielectric coating that maintains electrical isolation of this metal even under a thermal runaway event.

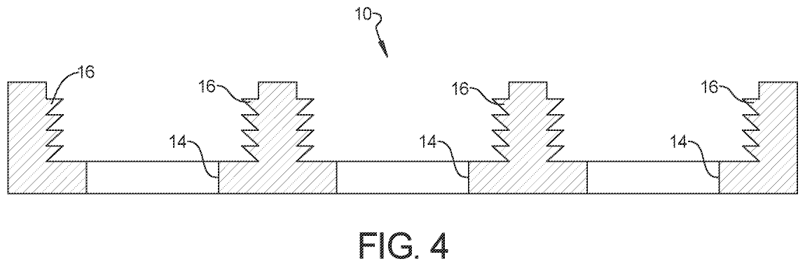

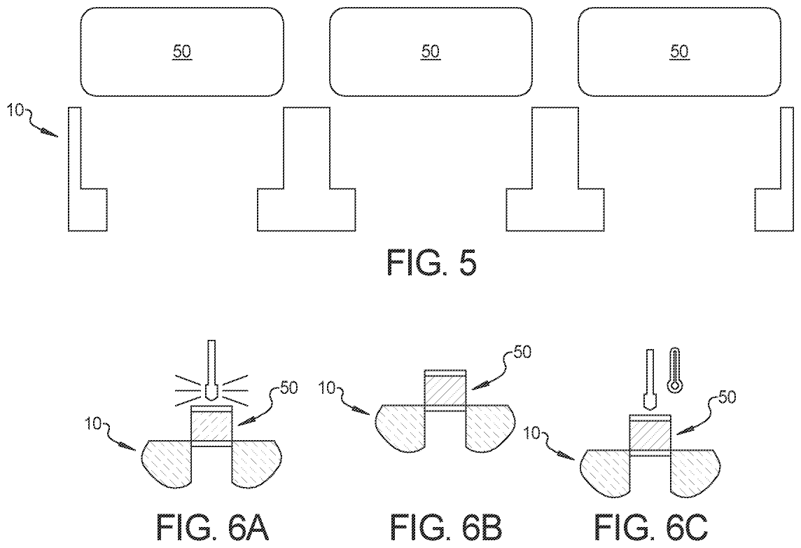

With reference to FIG. 4, a battery cell holder tray 10 is shown with the threaded interfaces 16 of each vent passage 14 being integrally formed with the battery cell holder tray 10. The threaded interfaces 16 can be molded with threads via injection, compression molding or via 3D printing. One or more materials can be used to make the tray. With further reference to FIG. 5, a threaded ring insert 50 can be formed with internal threads and the tray 10 can be over-mold around the threaded ring inserts 50 or the inserts 50 can be inserted into a pre-molded tray 10. In particular, as shown in FIG. 6A, the threaded ring inserts 50 can be inserted into the tray by ultrasonic insertion by applying ultrasonic vibration to the inserts 50 as they are pressed into the tray 10. With reference to FIG. 6B, the threaded ring inserts 50 can be press-fit into the tray 10. With reference to FIG. 6C, the threaded ring inserts 50 can be heat inserted into the tray 10 by heating the inserts so that they melt the plastic tray as they are inserted into the tray with the tray subsequently cooling and entrapping the inserts within the tray 10. The inserts 50 can be molded, cut or 3D printed from metal or plastic. The threaded ring inserts 50 can be made from metal and can be coated with a high temperature-resistant dielectric coating that maintains electrical isolation of this metal even under a thermal runaway event.

The cell holder tray 10 with threaded interfaces with the battery cells 12 having threaded interface allow the cells 12 to self-locate during the battery module assembly process and allow reversible fastening/unfastening of the cells 12 to the cell tray 10 using the threading between them. The threaded fastening enables easier servicing of the rechargeable energy storage system. The present disclosure creates a more structurally robust joining (vs. just an adhesive joining) and prevents the potting applied around the battery cells 12 from leaking into the vent channels 24.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A rechargeable energy storage system, comprising:
a cell holder tray including a plurality of vent passages each aligned with a corresponding one of a plurality of threaded features; and
a plurality of battery cells each threadedly joined to a respective one of the plurality of threaded features of the cell holder tray.

2. The rechargeable energy storage system according to claim 1, wherein the plurality of battery cells have an outer shell that is integrally threaded.

3. The rechargeable energy storage system according to claim 1, wherein the plurality of battery cells have a threaded sleeve.

4. The rechargeable energy storage system according to claim 3, wherein the threaded sleeve is made from metal.

5. The rechargeable energy storage system according to claim 3, wherein the threaded sleeve is made from one of a plastic and a composite material.

6. The rechargeable energy storage system according to claim 1, wherein the plurality of battery cells include one of a plastic shell and a composite shell.

7. The rechargeable energy storage system according to claim 1, wherein the plurality of battery cells include a metal shell.

8. The rechargeable energy storage system according to claim 1, wherein the plurality of battery cells are over-molded with a threaded sleeve.

9. The rechargeable energy storage system according to claim 1, wherein the plurality of threaded features of the cell holder tray are integrally formed with the cell holder tray.

10. The rechargeable energy storage system according to claim 1, wherein the cell holder tray includes an upper tray portion including the plurality of vent passages and the plurality of threaded features and a lower tray portion forming a plurality of vent channels in communication with the plurality of vent passages.

11. The rechargeable energy storage system according to claim 1, wherein the plurality of threaded features of the cell holder tray are formed from plastic.

12. The rechargeable energy storage system according to claim 1, wherein the plurality of threaded features of the cell holder tray are formed from metal.

13. The rechargeable energy storage system according to claim 1, wherein the plurality of threaded features of the cell holder tray are formed on an interior surface of a ring-shaped insert.

14. The rechargeable energy storage system according to claim 13, wherein the ring-shaped insert is ultrasonically inserted into the cell holder tray.

15. The rechargeable energy storage system according to claim 13, wherein the ring-shaped insert is heat inserted into the cell holder tray.

16. The rechargeable energy storage system according to claim 13, wherein the ring-shaped insert is press fit into the cell holder tray.

17. The rechargeable energy storage system according to claim 1, wherein the plurality of threaded features are molded into the cell holder tray.

18. The rechargeable energy storage system according to claim 1, wherein the plurality of threaded features are 3-D printed into the cell holder tray.

19. The rechargeable energy storage system according to claim 1, wherein the cell holder tray is made from plastic including one of nylon, polycarbonate, polypropylene and ABS.

20. A rechargeable energy storage system, comprising:
a cell holder tray including a plurality of vent passages each aligned with a corresponding one of a plurality of threaded features; and
a plurality of battery cells each threadedly joined to a respective one of the plurality of threaded features of the cell holder tray, wherein the cell holder tray includes an upper tray portion including the plurality of vent passages and the plurality of threaded features and a lower tray portion forming a plurality of vent channels in communication with the plurality of vent passages.
